(19) United States
(12) Patent Application Publication
(10) Pub. No.: US 2017/0228812 A1
(43) Pub. Date: Aug. 10, 2017

(54) SYSTEM AND METHOD FOR OPTIMIZING DELIVERING SOURCES OF ONLINE ORDERS

(71) Applicant: International Business Machines Corporation, Armonk, NY (US)

(72) Inventors: JoAnn P. Brereton, Hawthorne, NY (US); Ajay A. Deshpande, White Plains, NY (US); Hongliang Fei, Millwood, NY (US); Arun Hampapur, Norwalk, CT (US); Miao He, Beijing (CN); Kimberly D. Hendrix, New Albany, OH (US); Steve Igrejas, Newton, NH (US); Alan J. King, South Salem, NY (US); Yingjie Li, Chappaqua, NY (US); Xuan Liu, Yorktown Heights, NY (US); Christopher S. Milite, Oxford, CT (US); Jae-Eun Park, Wappingers Falls, NY (US); Vadiraja S. Ramamurthy, Allen, TX (US); Joline Ann V. Uichanco, Ann Arbor, MI (US); Songhua Xing, Sunnyvale, CA (US); Xiao Bo Zheng, ShangHai (CN)

(21) Appl. No.: 15/018,274

(22) Filed: Feb. 8, 2016

(51) Int. Cl. G06Q 30/06

(52) U.S. Cl. CPC G06Q 30/0635

(57) ABSTRACT

A method and system optimizing source selection of an online order with the lowest fulfillment cost by considering multiple types of parameters, including shipping costs, backlog costs and markdown savings of the order. The method includes obtaining an order from the order retrieval subsystem of the OMS, selecting the candidate sources, and retrieving data from retailers or shipping companies of each selected candidate sources. The system then calculates the costs and savings parameters of the candidate sources from the retrieved data. The system identifies all possible candidate sourcing selections of the order and calculates the total fulfillment cost of each sourcing selection of the order by adding the shipping costs with the backlog costs, and subtracting the markdown savings of all candidate sources in each sourcing selection. The system identifies the optimized sourcing selection of the order with the lowest fulfillment cost and renders the selection to the OMS.

### BACKGROUND

This disclosure is directed to computer generated sourcing selections and more particularly, to computer generated sourcing selections with the lowest fulfillment cost of an order.

Retailers have a number of options (channels) for fulfilling an online order, each having a different shipping cost. Orders are handled by an order management system (OMS). The OMS receives the orders in an order queue, applies a set of rules to make a selection of channels for assignment, assigns the orders to channels for fulfillment, enters the order into channel dispatch queues, tracks the status of the assignment, and if necessary re-enters a canceled order into the order queue. In an omni-channel system, the OMS must select a channel (or channels) to partially fulfill the order. The standard practice in the industry is to apply a set of rules to make the selection.

At peak periods, more orders arrive than can be processed by any given channel and backlogs may grow at the channels with the cheapest shipping cost, leading to undesirable delays in order processing. It is possible that large backlogs might be unavoidable because of the high demand. Therefore, the OMS is designed to assign orders so that the number of days to process the backlog (backlog days) be approximately the same across all dispatch queues.

### SUMMARY OF THE INVENTION

One embodiment is directed to a method for optimizing source selection of an online order with the lowest fulfillment cost. The method includes obtaining an order from the order retrieval subsystem of the OMS. The method also includes selecting the candidate sources (including stores/EFCs), and retrieving data from retailers or shipping companies of each selected candidate sources. The retrieved data comprising inventory, backlog data and markdown availability data. The method then includes calculating the costs and savings parameters of the candidate sources from the retrieved data. The cost parameters and saving parameters comprising shipping costs, markdown savings, cost per backlog day and backlog days. Further, the method includes identifying all possible candidate sourcing selections of the order and calculating the total fulfillment cost of each sourcing selection of the order by adding the shipping costs with the backlog costs, and subtracting the markdown savings of all candidate sources in each sourcing selection. Finally, the method includes identifying the optimized sourcing selection of the order with the lowest fulfillment cost and rendering the selection for the OMS to execute.

In one embodiment, if the optimized sourcing selection cannot be executed by the OMS, the system increases the inventory, backlog data and markdown availability data according to the number of the non-executed items. In another embodiment, if the optimized sourcing selection is executed by the OMS, the system decreases the inventory, backlog data and markdown availability data according to the number of the executed items.

In one embodiment, the system selects the plurality of candidate sources according to a mileage criterion from the order destination. In another embodiment, the system identifies a plurality of sourcing selections limited to a pre-determined number of sources pursuant to a minimal presentation constraint.

In one embodiment, the system calculates the markdown savings by multiplying unit price, markdown rate and cost component of price. In one embodiment, the system increases the backlog costs parameter to increase the priority of reducing backlogs during peak business periods. In another embodiment, the system increases of the markdown savings parameter to increase the priority of avoiding markdowns during non-peak business periods.

One embodiment of this disclosure is directed to a Short Term Optimization Model (STOM) for optimizing source selection of an online order with the lowest fulfillment cost. The computer system includes one or more non-transitory computer-readable storage media and program instructions, stored on the one or more non-transitory computer-readable storage media, which when implemented by a user interface accessing a service provider website, cause the computer system to perform the steps of selecting the candidate sources (including stores/EFCs), and retrieving data from retailers or shipping companies of each selected candidate sources. The method then includes calculating the costs and savings parameters of the candidate sources from the retrieved data. Further, the method includes identifying all possible candidate sourcing selections of the order and calculating the total fulfillment cost of each sourcing selection of the order by adding the shipping costs with the backlog costs, and subtracting the markdown savings of all candidate sources in each sourcing selection. Finally, the method includes identifying the optimized sourcing selection of the order with the lowest fulfillment cost and rendering the selection for the OMS to execute.

One embodiment is directed to a non-transitory article of manufacture tangibly embodying computer readable instructions, which when implemented, cause a computer to perform the steps of selecting the candidate sources (including stores/EFCs), and retrieving data from retailers or shipping companies of each selected candidate sources. The method then includes calculating the costs and savings parameters of the candidate sources from the retrieved data. Further, the method includes identifying all possible candidate sourcing selections of the order and calculating the total fulfillment cost of each sourcing selection of the order by adding the shipping costs with the backlog costs, and subtracting the markdown savings of all candidate sources in each sourcing selection. Finally, the method includes identifying the optimized sourcing selection of the order with the lowest fulfillment cost and rendering the selection for the OMS to execute.

### BRIEF DESCRIPTION OF THE DRAWINGS

These and other objects, features and advantages of the present invention will become apparent from the following detailed description, which is to be read in connection with the accompanying drawings, in which:

FIG. 1 is a block diagram of one embodiment of the system of the invention.

FIG. 2 is a block diagram of one embodiment of the integration between the system of the invention with an Order Management System (OMS), a store shipping system and a merchant inventory system.

FIG. 3 is a flow chart of the steps of one embodiment of the method of the invention.

FIG. 4 is a block diagram of an exemplary computing system suitable for implementation of this invention.

### DETAILED DESCRIPTION

This invention is a system and method for optimizing source selections of an online order and assigning the selections to an omni-channel system for execution. In one embodiment, the system and method minimizes the fulfillment cost of an order by considering multiple types of parameters, including shipping costs, backlog costs and markdown savings of the order to optimize the source selections. The invention combines cost-to-serve with time-to-fulfill, providing retailers with optimized sourcing selections to fulfill orders.

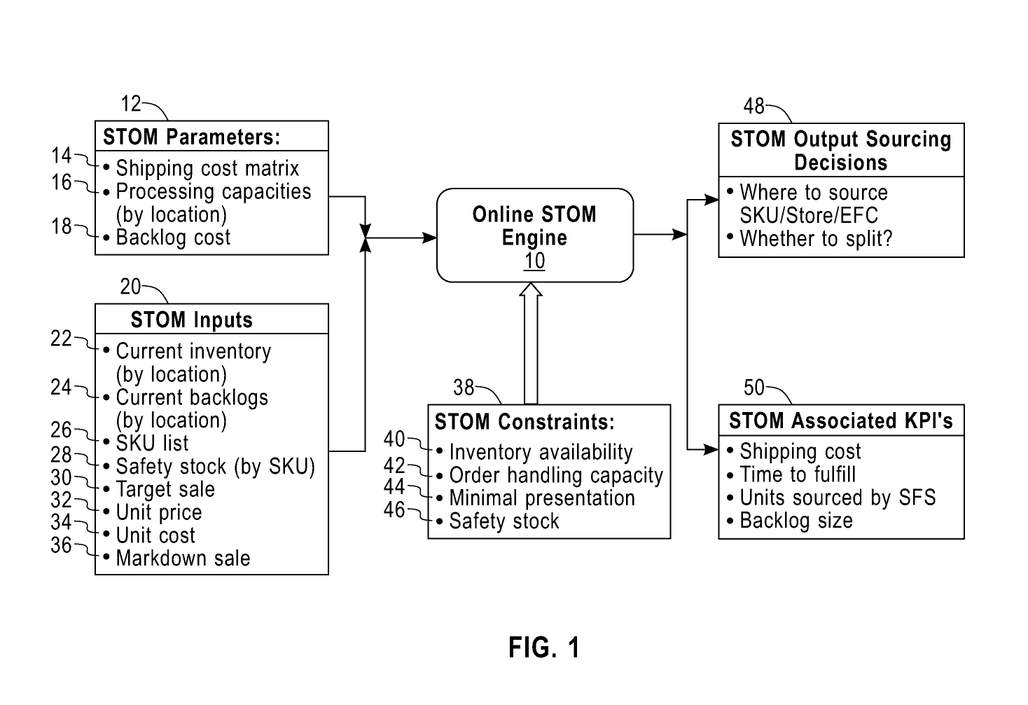

As is shown in FIG. 1, the diagram depicts one embodiment of the online Short Term Optimization Model (STOM) engine 10. The STOM parameters 12 include each store's shipping costs 14, processing capacity 16 and backlog costs 18. STOM inputs 20 include each store's current inventory 22, current backlogs 24, SKU (Stock Keeping Unit) list 26, safety stock by SKU 28, target sale 30, unit price 32, unit cost 34 and markdown rate 36. Aiming to minimize the fulfillment cost, including markdown avoidance, backlog reduction and shipping cost reduction, the STOM 10 applies an algorithm described in table 1 to calculate the lowest fulfillment cost using STOM parameters 12 and STOM inputs 20. The calculation is constrained by STOM constraints 38. The STOM constraints 38 include inventory availability 40, order handling capacity 42, minimal presentation 44 and safety stock 46. The safety stock 46 identifies the minimum number of items to be held in inventory at the stores. The minimal presentation constraint limits the number of sources in a sourcing combination identified by the STOM output sourcing decisions 48 to a pre-determined number. The STOM 10 identifies STOM output sourcing decisions 48 of whether to split the shipping source and the optimized sourcing selection with the lowest fulfillment cost. If the lowest fulfillment cost is from one shipping source, the decision will be not splitting the shipping source. If the lowest fulfillment cost is from a combination of sources, the decision will be splitting the shipping source to the combination of sources with the lowest fulfillment cost. The STOM also identifies the STOM associated KPIs (Key Performance Indicator) 50, including shipping costs, time to fulfill, unites sourced by SFS and backlog size, for use in evaluating performance.

As shown in Table 1, the algorithm illustrates an example of the STOM. The total fulfillment cost is the addition of shipping cost plus backlog cost, less markdown savings.

TABLE 1
Short-term optimization model

$\begin{matrix} Shipping & Markdown & \\ cost & savings & Backlog cost \\ {minimize }_{z , u , σ , θ} ( {\sum }_{i} {c}_{ij}^{SHIP} {Z}_{i} ) - & ( {\sum }_{k εκ} {c}_{k}^{ST} {σ}_{ik} ) + & ( {\sum }_{i} {c}_{i}^{B} {BD}_{i} {Z}_{i} )\end{matrix}$

| | |
|---|---|
| subject to | ${\sum }_{i} {Z}_{i} \leq Γ Limit on the no . of \\ packages$ |
| | ${\sum }_{i} {u}_{ik} = {q}_{k} , ∀ k ∈ κ Sourced units must equal \\ ordered units$ |
| | ${u}_{ik} \leq {X}_{ik} {Z}_{i} , ∀ i , k ∈ κ Sourced units from a node \\ only if there is inventory$ |
| | ${σ}_{ik} \leq min \{ {TS}_{ik} , {u}_{ik} \} ∀ i , k ∈ κ Units saved from markdown$ |
| | ${u}_{ik} ∈ {•}^{+} , {Z}_{i} ∈ \{ 0 , 1 \} , {σ}_{ik} ∈ •$ |

The total shipping cost equals the sum of the shipping cost per package from candidate sources identified by the optimization model. Cᵢⱼ^{SHIP} (Shipping cost per package from a store i to an order destination j) can be obtained from the retailer or the shipping companies. Shipping costs are usually based on the mileage from the destination where the package is dispatched to. For example, shipping costs from USPS is determined by pre-defined zones. Those pre-defined zones are decided by the mileage radius from the point of the order destination. The candidate sources are selected according to a mileage criterion from the order destination. The candidate sources are confined only to those within the mileage criterion. Zᵢ is an indicator that equals 1 if a package is shipped from a store. Γ is the maximum number of packages per order, meaning the number of separate sources of an order is limited. The optimization model provides all possible selections of the suitable shipping sources. If the selection is one source for shipping, the total shipping cost is the shipping cost per package from the selected shipping source. If the selection is a combination of sourcing, the model then calculates the total shipping cost by summing the shipping cost per store for each combination given by the model.

The total markdown savings is the sum of the markdown savings per unit. Markdown Savings Per Unit=Unit Price*Markdown rate*Cost Component of Price. Cost Component of Price=Unit Cost/Unit Price. Unit price, unit cost and markdown rate are monitored, calculated and provided by retailers. Cₖ^{ST} is the markdown savings per item with SKU k. σi^{k} stands for the ordered units that are markdown eligible for SKU k at store i. Each store has a target sale expectation. Each inventory-at-risk is calculated by target sales minus current sales, that is, the number of items not sold with respect to expectations due to various reasons. Only when the inventory-at-risk is higher than zero, would the item be regarded as a potential markdown savings target. Xᵢₖ is the inventory of SKU k at store i. A store will be chosen only if that store has an inventory of the ordered item. K denotes the SKU numbers that are in the order. μᵢₖ is the quantity of SKU k shipped from store i, and qₖ is the quantity of SKU k in an order. Sourced units Σμᵢₖ must equal ordered units qₖ, meaning the total number of items shipped from different sources equals the number of items consumers have ordered. TSᵢₖ means units of SKU k available for markdown at store i. Units saved from markdown per store σᵢₖ must be less than the minimum of units available for markdown at the store TSᵢₖ and the quantity shipped from the store μᵢₖ. The markdown saving per store is determined by multiplying the markdown savings per item with SKU k by the ordered units that are markdown eligible for SKU k at the store. If the selection is one source for shipping, the total markdown saving is the markdown savings of the selected shipping source. If the selection is a combination of sourcing, the model then calculates the total markdown saving by summing the markdown savings per store for each combination given by the model.

The total backlog cost is the sum of backlog cost per unit. Backlog Cost Per Store=Cᵢ^{B}*BDᵢZᵢ. Cᵢ^{B} represents cost per backlog day at store i. BDᵢ represents backlog days of store i, meaning the time to service a package at the store. Backlog days are determined by dividing the current backlog by processing capacity per day (UPD). If the selection is one source for shipping, the total backlog cost is the backlog cost of the selected shipping source. If the selection is a combination of sourcing, the model then calculates the total backlog cost by summing the backlog cost per store of each combination given by the model.

Finally, for each selection, the model sums the total shipping cost and the total backlog cost and subtracts the total markdown savings, which provides the retailer with the total fulfillment cost involved in a transaction for each selection. The short-term optimization model then outputs whether to split an order into several source deliveries, and identifies the source selection with the lowest fulfillment cost, allowing the store to minimize cost by shipping from the identified sources.

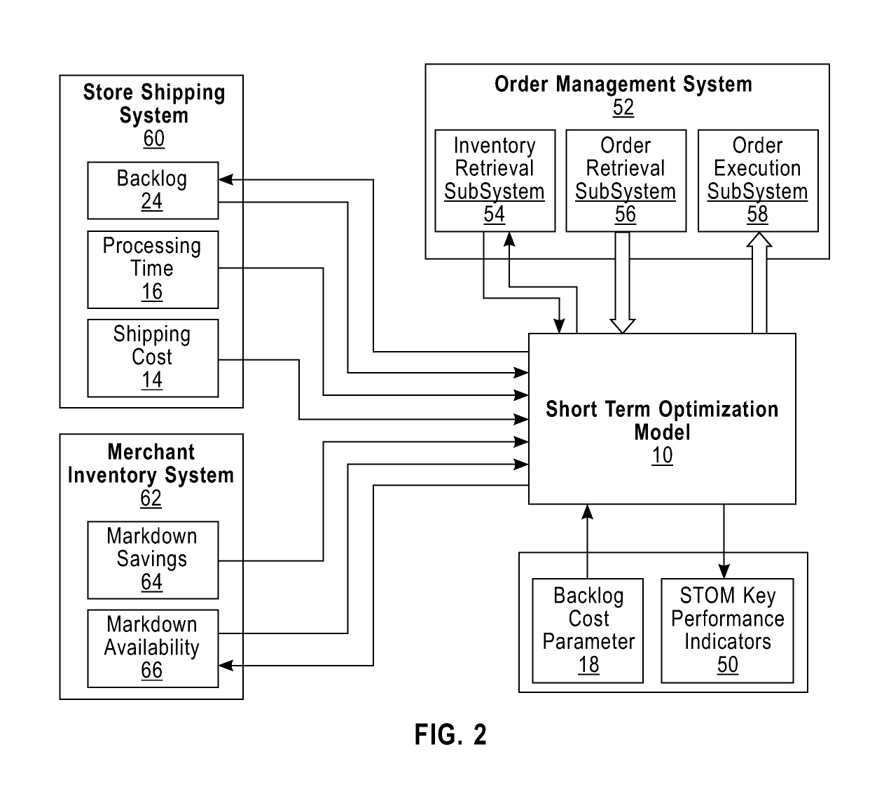

As shown in FIG. 2, the diagram depicts one embodiment of the integration between the STOM 10 with an Order Management System (OMS) 52, a store shipping system 60 and a merchant inventory system 62. An example of the OMS is the Sterling Order Management System (Sterling OMS). The OMS 52 includes an inventory retrieval module 54, an order retrieval module 56 and an order execution module 58. The inventory retrieval module 52 obtains inventories of the ordered items at stores selected by the STOM 10. The order retrieval module 56 obtains orders from order queues listing orders from consumers. The order execution module 58 executes the optimized sourcing selections from the STOM output sourcing decisions 48.

The store shipping system 60 obtains backlog data 24 and processing capacity 16 from retailers. The store shipping system 60 also obtains shipping cost parameter 14 from retailers or shipping companies. The backlog data 24, processing capacity 16 and shipping cost parameter 14 are considered by the STOM 10 for identification of an optimized sourcing selection. In one embodiment, if the optimized sourcing selection cannot be fulfilled by the OMS 52, the STOM 10 increases the backlog status 24 according to the number of the non-fulfilled items. In another embodiment, if the optimized sourcing selection is fulfilled by the OMS 52, the STOM 10 decreases the backlog status 24 according to the number of the fulfilled items.

The merchant inventory system 62 obtains markdown saving parameters 64 and markdown availability data 66, both of which are gathered from retailers. The markdown saving parameters 64 and markdown availability 66 are considered by the STOM 10 for identification of an optimized sourcing selection. In one embodiment, if the optimized sourcing selection cannot be fulfilled by the OMS 52, the STOM 10 increases the markdown availability data 66 according to the number of the non-fulfilled items. In another embodiment, if the optimized sourcing selection is fulfilled by the OMS 52, the STOM 10 decreases the markdown availability data 66 according to the number of the fulfilled items.

Backlog cost parameters 18 are further considered by the STOM 10 for identification of an optimized sourcing selection. The STOM 10 identifies STOM KPIs 50 for STOM performance management.

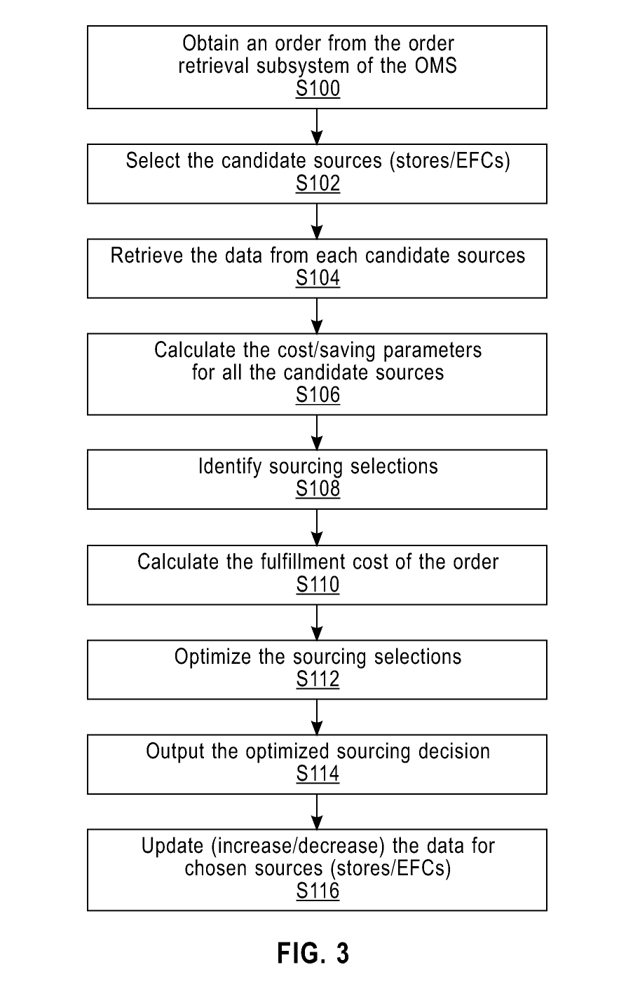

As is shown in FIG. 3, one embodiment of the method of the invention begins with step S100 of obtaining an order from the order retrieval subsystem of the OMS. At step S102, the system selects the candidate sources (including stores/EFCs).

At step S104, the system retrieves data from retailers or shipping companies of each selected candidate sources. Retrieved data includes inventory of SKU (Stock Keeping Unit) k at store i, units of SKU k available for markdown savings at store i, shipping backlog at store i. Further at step S106, the system calculates the costs and savings parameters from the retrieved data. Costs and savings parameters includes shipping costs to each destination j from each store i, markdown savings for SKU k, cost per backlog day and time to service a package at store i (backlog days).

At step S108, the system identifies all possible candidate sourcing selections of the order. Each identified candidate sourcing selection includes one or more candidate source. At step S110, the system calculates the total fulfillment cost of each sourcing selection of the order by adding the shipping costs with the backlog costs, and subtracting the markdown savings of all candidate sources in each sourcing selection. Then at step S112, the system identifies the optimized sourcing selection of the order with the lowest fulfillment cost. Further at step S114, the system renders output of the optimized sourcing selection for the OMS to execute. The OMS executes by using a channel (or channels) connecting each of the optimized sources with the destination.

In one embodiment, if the optimized sourcing selection cannot be executed by the OMS, the system increases the inventory, backlog data and markdown availability data according to the number of the non-executed items. In another embodiment, if the optimized sourcing selection is executed by the OMS, the system decreases the inventory, backlog data and markdown availability data according to the number of the executed items.

In one embodiment, the system selects the plurality of candidate sources according to a mileage criterion from the order destination. In another embodiment, the system identifies a plurality of sourcing selections limited to a pre-determined number of sources pursuant to a minimal presentation constraint.

In one embodiment, the system calculates the markdown savings by multiplying unit price, markdown rate and cost component of price.

In one embodiment, the system increases the backlog costs parameter to increase the priority of reducing backlogs during peak business periods. In another embodiment, the system increases of the markdown savings parameter to increase the priority of avoiding markdowns during non-peak business periods.

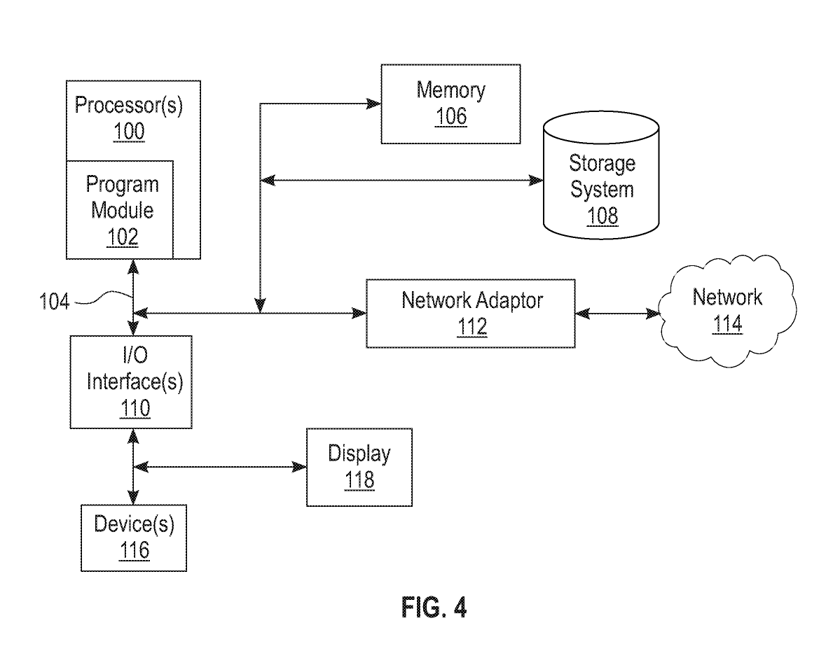

FIG. 4 illustrates a schematic of an example computer or processing system that may implement the method for optimizing source selection of an online order with the lowest fulfillment cost. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 3 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 100, a system memory 106, and a bus 104 that couples various system components including system memory 106 to processor 100. The processor 100 may include a program module 102 that performs the methods described herein. The module 102 may be programmed into the integrated circuits of the processor 100, or loaded from memory 106, storage device 108, or network 114 or combinations thereof.

Bus 104 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 106 can include computer system readable media in the form of volatile memory, such as random access memory (RAM) and/or cache memory or others. Computer system may further include other removable/non-removable, volatile/non-volatile computer system storage media. By way of example only, storage system 108 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 104 by one or more data media interfaces.

Computer system may also communicate with one or more external devices 116 such as a keyboard, a pointing device, a display 118, etc.; one or more devices that enable a user to interact with computer system; and/or any devices (e.g., network card, modem, etc.) that enable computer system to communicate with one or more other computing devices. Such communication can occur via Input/Output (I/O) interfaces 110.

Still yet, computer system can communicate with one or more networks 114 such as a local area network (LAN), a general wide area network (WAN), and/or a public network (e.g., the Internet) via network adapter 112. As depicted, network adapter 112 communicates with the other components of computer system via bus 104. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product. The computer program product may include a non-transitory computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

In addition, while preferred embodiments of the present invention have been described using specific terms, such description is for illustrative purposes only, and it is to be understood that changes and variations may be made without departing from the spirit or scope of the following claims.

1. A computer implemented method for optimizing selections for sourcing an online order for a plurality of items, comprising:
obtaining an order for a plurality of items from an internet on-line order retrieval subsystem of an order management system (OMS) of a merchant;
automatically selecting a plurality of candidate sources from the OMS;
automatically retrieving data of the selected candidate sources, including retrieving inventory data obtained from a merchant inventory subsystem, backlog data obtained from a source shipping subsystem for each candidate source and markdown availability data obtained from the merchant inventory subsystem, the markdown availability data including unit price, unit cost and markdown rate for each item;
automatically calculating cost parameters and saving parameters of each of the selected candidate sources by utilizing the retrieved data, the cost parameters and saving parameters comprising shipping costs, markdown savings, cost per backlog day and backlog days, including calculating the markdown savings based on the markdown availability data;
automatically identifying a plurality of sourcing selections of the order from the selected candidate sources, each sourcing selection comprising one or more candidate source;
automatically calculating a fulfillment cost for each sourcing selection of the order by adding the shipping costs with the backlog costs, and subtracting the markdown savings of all candidate sources in each sourcing selection;
automatically applying constraints to the fulfillment cost calculation based on order handling capacity data and safety stock data obtained from the source shipping subsystem for each sourcing selection;
automatically generating a sourcing selection of the order with the lowest fulfillment cost based on the applied constraints;
automatically providing the sourcing selection with the lowest fulfillment cost based on the applied constraints to the OMS for order execution.

2. The computer implemented method of claim 1, further comprising increasing the inventory, backlog data and markdown availability data according to a number of non-executed items in the order.

3. The computer implemented method of claim 1, further comprising decreasing the inventory, backlog data and markdown availability data according to a number of executed items in the order.

4. The computer implemented method of claim 1, wherein the plurality of candidate sources is selected according to a mileage criterion or shipping zone criterion from the order destination.

5. The computer implemented method of claim 1, wherein the number of identified sourcing selections is limited to a pre-determined number of sources pursuant to a minimal presentation constraint.

6. The computer implemented method of claim 1, wherein the markdown savings is a unit price multiply by a markdown rate and multiply by a cost component of price.

7. The computer implemented method of claim 1, further comprising an increase of the backlog costs parameter to increase the priority of reducing backlogs.

8. The computer implemented method of claim 1, further comprising an increase of the markdown savings parameter to increase the priority of avoiding markdowns.

9. A computer system for optimizing selections for sourcing an online order for a plurality of items, comprising:
a memory; and
a processor configured to:
obtaining an order for a plurality of items from an internet on-line order retrieval subsystem of an order management system (OMS) of a merchant;
automatically selecting a plurality of candidate sources from the OMS;
automatically retrieving data of the selected candidate sources, including retrieving inventory data obtained from a merchant inventory subsystem, backlog data obtained from a source shipping subsystem for each candidate source and markdown availability data obtained from the merchant inventory subsystem, the markdown availability data including unit price, unit cost and markdown rate for each item;
automatically calculating cost parameters and saving parameters of each of the selected candidate sources by utilizing the retrieved data, the cost parameters and saving parameters comprising shipping costs, markdown savings, cost per backlog day and backlog days, including calculating the markdown savings based on the markdown availability data;
automatically identifying a plurality of sourcing selections of the order from the selected candidate sources, each sourcing selection comprising one or more candidate source;
automatically calculating a fulfillment cost for each sourcing selection of the order by adding the shipping costs with the backlog costs, and subtracting the markdown savings of all candidate sources in each sourcing selection;
automatically applying constraints to the fulfillment cost calculation based on order handling capacity data and safety stock data obtained from the source shipping subsystem for each sourcing selection;
automatically generating a sourcing selection of the order with the lowest fulfillment cost based on the applied constraints;
automatically providing the sourcing selection with the lowest fulfillment cost based on the applied constraints to the OMS for order execution.

10. The computer system of claim 9, further comprising increasing the inventory, backlog data and markdown availability data according to a number of non-executed items in the order and decreasing the inventory, backlog data and markdown availability data according to a number of executed items in the order.

11. The computer system of claim 9, wherein the plurality of candidate sources is selected according to a mileage criterion from the order destination.

12. The computer system of claim 9, wherein the number of identified sourcing selections is limited to a pre-determined number of sources pursuant to a minimal presentation constraint.

13. The computer system of claim 9, wherein the markdown savings is a unit price multiply by a markdown rate and multiply by a cost component of price.

14. The computer system of claim 9, further comprising an increase of the backlog costs parameter to increase the priority of reducing backlogs.

15. The computer system of claim 9, further comprising an increase of the markdown savings parameter to increase the priority of avoiding markdowns.

16. A non-transitory article of manufacture tangibly embodying computer readable instructions, which when implemented, cause a computer to perform the steps of a method for sourcing an online order for a plurality of items, comprising:
obtaining an order for a plurality of items from an internet on-line order retrieval subsystem of an order management system (OMS) of a merchant;
automatically selecting a plurality of candidate sources from the OMS;
automatically retrieving data of the selected candidate sources, including retrieving inventory data obtained from a merchant inventory subsystem, backlog data obtained from a source shipping subsystem for each candidate source and markdown availability data obtained from the merchant inventory subsystem, the markdown availability data including unit price, unit cost and markdown rate for each item;
automatically calculating cost parameters and saving parameters of each of the selected candidate sources by utilizing the retrieved data, the cost parameters and saving parameters comprising shipping costs, markdown savings, cost per backlog day and backlog days, including calculating the markdown savings based on the markdown availability data;
automatically identifying a plurality of sourcing selections of the order from the selected candidate sources, each sourcing selection comprising one or more candidate source;
automatically calculating a fulfillment cost for each sourcing selection of the order by adding the shipping costs with the backlog costs, and subtracting the markdown savings of all candidate sources in each sourcing selection;
automatically applying constraints to the fulfillment cost calculation based on order handling capacity data and safety stock data obtained from the source shipping subsystem for each sourcing selection;
automatically generating a sourcing selection of the order with the lowest fulfillment cost based on the applied constraints;
automatically providing the sourcing selection with the lowest fulfillment cost based on the applied constraints to the OMS for order execution.

17. The non-transitory article of manufacture of claim 15, further comprising increasing the inventory, backlog data and markdown availability data according to a number of non-executed items in the order and decreasing the inventory, backlog data and markdown availability data according to a number of executed items in the order.

18. The non-transitory article of manufacture of claim 15, wherein the plurality of candidate sources is selected according to a mileage criterion from the order destination.

19. The non-transitory article of manufacture of claim 15, wherein the number of identified sourcing selections is limited to a pre-determined number of sources pursuant to a minimal presentation constraint.

20. The non-transitory article of manufacture of claim 15, wherein the markdown savings is a unit price multiply by a markdown rate and multiply by a cost component of price.

21. The non-transitory article of manufacture of claim 15, further comprising an increase of the backlog costs parameter to increase the priority of reducing backlogs.

22. The non-transitory article of manufacture of claim 15, further comprising an increase of the markdown savings parameter to increase the priority of avoiding markdowns.
